(19) United States
(12) Patent Application Publication
(10) Pub. No.: US 2026/0102682 A1
(43) Pub. Date: Apr. 16, 2026

(54) PORTABLE EXERCISE STATION WITH TRUCK BED INTEGRATION

(71) Applicant: Andrew Rehling, Madison, MS (US)

(72) Inventor: Andrew Rehling, Madison, MS (US)

(21) Appl. No.: 19/372,187

(22) Filed: Oct. 28, 2025

Related U.S. Application Data
(60) Provisional application No. 63/707,066, filed on Oct. 14, 2024.

(51) Int. Cl. A63B 71/02; B60D 1/52; B60R 9/08

(52) U.S. Cl. CPC A63B 71/023; B60R 9/08; A63B 2225/11; B60D 1/52

(57) ABSTRACT

A portable exercise station configured for deployment from truck bed is disclosed. Portable exercise station includes H-frame with first and second columns and cross member. Portable exercise station is supported by and slides along rails affixed to truck bed, allowing it to be easily pulled out and deployed on ground. Portable exercise station includes detachable cross member with U-shaped brackets for adjustable positioning along first and second columns. Foldable load-bearing supports, which are adjustable in height, provide additional stability during use. Hitch attachment assembly, which includes coupler, allows for pivotal movement of portable exercise station relative to truck bed. Coupler may include bearing interface or dampening mechanism for controlled rotation. Portable exercise station is designed for multiple exercise applications, such as squats, bench presses, and pull-ups, and can be compactly stored when not in use.

### CROSS-REFERENCE TO RELATED APPLICATIONS

The present application claims benefit of U.S. Provisional Application No. 63/707,066, filed Oct. 14, 2024; which is incorporated herein in its entirety and referenced thereto.

### BACKGROUND OF THE INVENTION

### Field of the Invention

The present invention relates to sports and fitness equipment, and more particularly, to a portable exercise station designed for vehicle integration, specifically within the bed of a truck, which allows for rapid setup and versatile use by fitness enthusiasts in various outdoor and mobile environments.

### Description Of The Prior Art

In today's fast-paced world, maintaining a regular fitness routine is challenging, especially for individuals who travel frequently or lack access to a traditional gym. The demand for portable exercise equipment that is versatile, easy to transport, and quick to set up has grown significantly. Fitness enthusiasts are increasingly looking for solutions that allow them to perform a wide range of exercises without the constraints of a fixed location. To meet this demand, various portable workout stations have been developed that can be mounted on vehicles, but these solutions often fall short in terms of convenience, stability, and ease of use.

Several attempts to create portable vehicle-mounted workout stations are found in the prior art. For example, AU2017101677A4, entitled “Improved Vehicle Mounted Weight Rack,” describes a workout station that can be stabilized by a vehicle or a secured mounting plate. The weight rack is attached to a vehicle's hitch, or a ground-engaging plate secured by the vehicle's weight, incorporating vertical supports and adjustable jacks for heavy weightlifting exercises. However, this design is complex and requires considerable setup time, making it impractical for users who need a quick and efficient workout solution. Moreover, the necessity of manually adjusting jacks and assembling multiple components detracts from its overall utility and portability.

Another example is provided by U.S. Publication No. US20070259764A1, titled “Detachable Exercise Device for Use with a Vehicle. ” This publication discloses a detachable exercise device that can be temporarily or permanently attached to a vehicle's tow hitch. While this design supports a variety of strength training and cardiovascular exercises, it requires multiple steps to secure the device to the vehicle and assemble the exercise components, reducing its appeal to users seeking a rapid deployment solution. Its cumbersome setup process limits its effectiveness for quick workouts, especially in outdoor or transient settings.

U.S. Pat. No. 9,302,144B1, titled “Mobile Exercise System,” introduces a different approach by mounting a workout station on a vehicle's roof rack. This system allows for exercises such as pull-ups and dips and is easily transportable on a vehicle's roof. However, this design occupies valuable roof space, potentially conflicting with other transportation needs like carrying luggage or equipment. Additionally, mounting and dismounting from a roof rack involves additional steps and safety concerns, particularly for users looking for a hassle-free workout setup.

While these prior art references offer some degree of portability and utility, they are constrained by significant limitations. The existing systems are often bulky, complex, and time-consuming to set up, diminishing their effectiveness as truly portable workout solutions. They do not adequately address the need for a compact, easily deployable exercise station that offers both stability and versatility in a mobile environment. Moreover, these systems often occupy critical storage areas of a vehicle, reducing their appeal for users who require multifunctional use of their vehicle space.

Therefore, there is a pressing need in the art for an improved portable workout station that can be stored compactly within a vehicle, quickly deployed with minimal effort, and utilized effectively across a variety of settings without compromising vehicle utility or storage capacity.

### SUMMARY OF THE INVENTION

It is an object of the present invention to provide portable exercise station that can be easily transported on truck bed and deployed at any location for performing various exercises, thereby enhancing convenience and accessibility for users who prefer outdoor or remote workout environments.

It is another object of the present invention to provide portable exercise station that is configured on truck bed and deployed using hitch attachment assembly, allowing for secure and stable exercise platform that can be quickly set up and taken down.

It is another object of the present invention to provide portable exercise station with a pivotally mounted structure that enables portable exercise station to be deployed in multiple orientations, providing flexibility in workout configurations and accommodating different types of exercises.

To achieve one or more of these objects, the present invention provides a portable exercise station that includes an H-frame. The H-frame has a first column, a second column, and a first cross member adjoined to operative top ends of the first column and the second column, forming the primary framework for supporting various exercise components. The H-frame is supported by and slides along rails affixed to a truck bed, allowing the portable exercise station to be easily pulled out from the truck bed and deployed on ground.

The portable exercise station further includes a detachable cross member that enhances stability and rigidity of the H-frame during use. The detachable cross member comprises U-shaped brackets positioned at a first operative end and a second operative end of the detachable cross member, which are configured to engage with the first column and the second column of the H-frame, allowing for secure attachment and adjustable positioning.

In one aspect of the present invention, the portable exercise station includes foldable load-bearing supports pivotally connected to the H-frame. The includes foldable load-bearing supports are height-adjustable and configured to fold against the H-frame when not in use and to extend outward from the H-frame to provide stability during use. The foldable load-bearing supports comprise a first U-shaped member and a second U-shaped member. The second U-shaped member is configured for telescopic fitment within the first U-shaped member, allowing users to adjust the height of the portable exercise station according to their needs.

In another aspect of the present invention, the portable exercise station is equipped with a hitch attachment assembly configured to connect the portable exercise station to a truck bed of a truck. The hitch attachment assembly comprises a coupler configured to allow pivotal movement of the portable exercise station, enabling it to be deployed in various positions relative to the truck bed, such as perpendicular or at an angle, depending on the user's requirements.

In another embodiment, the coupler comprises a bearing interface that reduces friction and allows for smooth, controlled rotation of the portable exercise station. The bearing mechanism is designed to support the weight of the portable exercise station and any additional load from exercise equipment or users, ensuring stability and safety during use.

In another embodiment, the coupler may comprise a dampening mechanism, such as hydraulic or pneumatic components, configured to control the speed and smoothness of the pivotal movement, providing a gradual and controlled deployment process.

The portable exercise station is designed to accommodate various exercise applications beyond use as a squat rack. The portable exercise station can be configured for bench pressing, pull-ups, or other strength training exercises by attaching additional accessories or modifying the arrangement of the foldable load-bearing supports and cross members.

The foldable design of the portable exercise station allows for easy transport and storage, as it can be compactly folded and stored in a vehicle or small storage space when not in use, making it ideal for users with limited storage options or those who frequently move their workout equipment.

In one advantageous feature of the present invention, the portable exercise station includes holders provided on the foldable load-bearing supports for supporting exercise equipment, which can be positioned at various heights to support different types of weights or to adjust the height of a barbell, providing versatility in exercise setups.

In another advantageous feature of the present invention, the portable exercise station may further comprise a pull-up bar configured to be attached to the foldable load-bearing supports, helping users perform a wide range of exercises, including squats, bench presses, pull-ups, and other strength training exercises, thereby enhancing flexibility, strength, and overall fitness.

These and other objects of the present invention will be apparent from review of the following specification and the accompanying drawings.

### BRIEF DESCRIPTION OF THE DRAWINGS

FIG. 1 is an environment in which a portable exercise station implements, in accordance with one exemplary embodiment of the present subject matter.

FIG. 2 is a perspective view of portable exercise station being pulled out of a truck bed, in accordance with one embodiment of the present subject matter.

FIG. 3 is a perspective view of portable exercise station being pulled out of a truck bed with arrows indicating pivotal movement required for deployment thereof, in accordance with one embodiment of the present subject matter.

FIG. 4 is an exploded view of hitch attachment assembly used for deployment of portable exercise station, in accordance with one embodiment of the present subject matter.

FIG. 5 is an exploded view of portable exercise station, in accordance with one embodiment of the present subject matter.

FIG. 6 is a perspective view of portable exercise station being partially deployed on ground, in accordance with one embodiment of the present subject matter.

FIG. 7 is a perspective view of portable exercise station being deployed on ground, in accordance with one embodiment of the present subject matter.

FIG. 8 is a perspective view of portable exercise station being deployed on ground and having a barbell placed thereon, in accordance with one embodiment of the present subject matter.

### DETAILED DESCRIPTION OF THE PREFERRED EMBODIMENT

The detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed mat. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed mat.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

The following detailed description is merely exemplary in nature and is not intended to limit the described embodiments or the application and uses of the described embodiments. As used herein, the word “exemplary” or “illustrative” means “serving as an example, instance, or illustration. ” Any implementation described herein as “exemplary” or “illustrative” is not necessarily to be construed as preferred or advantageous over other implementations. All of the implementations described below are exemplary implementations provided to enable persons skilled in the art to make or use the embodiments of the subject matter and are not intended to limit the scope of the subject matter.

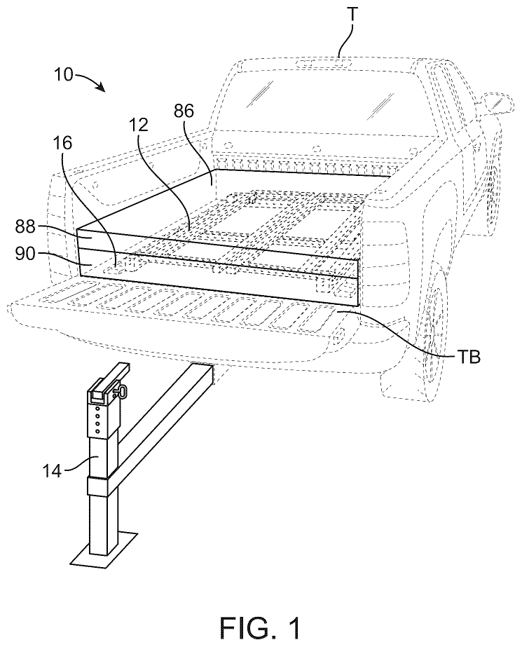

Various features and embodiments of a portable exercise station are explained in conjunction with the description of FIGS. 1-8.

FIG. 1 shows an environment 10 in which a portable exercise station 12 implements, in accordance with one exemplary embodiment of the present subject matter. Portable exercise station 12 is configured on a truck bed TB of a truck T. Portable exercise station 12 can be easily transported on truck bed TB to any location of choice and can be conveniently deployed using a hitch attachment assembly 14, as will be described in subsequent sections of present disclosure. In an embodiment, portable exercise station 12 further includes a storage housing 86. Storage housing 86 has a compartmentalized configuration defined by an operative upper compartment 88 and an operative lower compartment 90. In accordance with one exemplary embodiment, operative lower compartment 90 is configured to accommodate portable exercise station 12 and hitch attachment assembly 14. In other words, the dimensions of operative lower compartment 90 are specifically designed to house the folded H-frame 50. Operative upper compartment 88 has a height lower than that of operative lower compartment 90. This is attributed to the reason that operative upper compartment 88 is provided for the purpose of storing weight plates, barbell, and other exercise equipment. The upper compartment 88 may include adjustable dividers or foam padding to prevent equipment from shifting during transport and to protect against damage. Storing such exercise equipment requires less space as compared to storing of hitch attachment assembly 14 and portable exercise station 12. In an alternative embodiment, storage housing 86 may be constructed from weather-resistant materials such as marine-grade aluminum or high-density polyethylene (HDPE) to protect the equipment from environmental elements. Storage housing 86 may further include drainage ports to prevent water accumulation and ventilation slots to reduce condensation buildup. In yet another embodiment, storage housing 86 may incorporate a locking mechanism, such as a keyed lock or combination lock, to secure the equipment during transport and prevent theft.

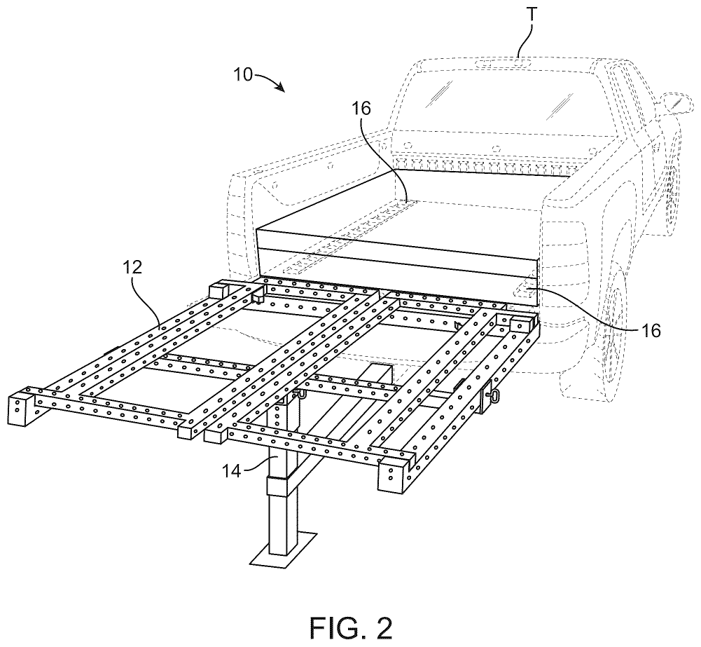

FIG. 2 is a perspective view of a portable exercise station being pulled out of a truck bed, in accordance with one embodiment of the present subject matter. As shown in FIG. 2, the portable exercise station 12 can be pulled out of the truck bed TB easily using rails 16. Rails 16 are disposed on and affixed to the truck bed TB. The rails 16 are configured adjacent to the lateral edges of the truck bed TB, allowing the portable exercise station 12 to be securely housed within the truck bed TB when not in use and to be easily accessed when needed. In one example, rails 16 are constructed from a durable material, e.g., steel or aluminum, to support the weight of portable exercise station 12 and to ensure smooth sliding motion. Rails 16 may have a load capacity ranging from 200 to 500 pounds to accommodate the weight of the exercise station and associated equipment. In one embodiment, rails 16 may include a locking mechanism to secure portable exercise station 12 in place during transport, thereby preventing unintended movement or deployment while the vehicle is in motion. The locking mechanism may comprise spring-loaded pins that engage with corresponding holes in the exercise station frame, or cam-operated clamps that secure the station at predetermined positions along the rails. In yet another embodiment, rails 16 may be telescoping rails that extend and retract to accommodate different sizes of portable exercise stations or various configurations of truck beds. The telescoping feature may provide an additional 12 to 24 inches of extension beyond the truck bed, facilitating easier access and deployment of the exercise station. In an alternative configuration, rails 16 may incorporate ball-bearing slides or linear bearings to reduce friction and ensure smooth operation even under heavy loads or adverse weather conditions.

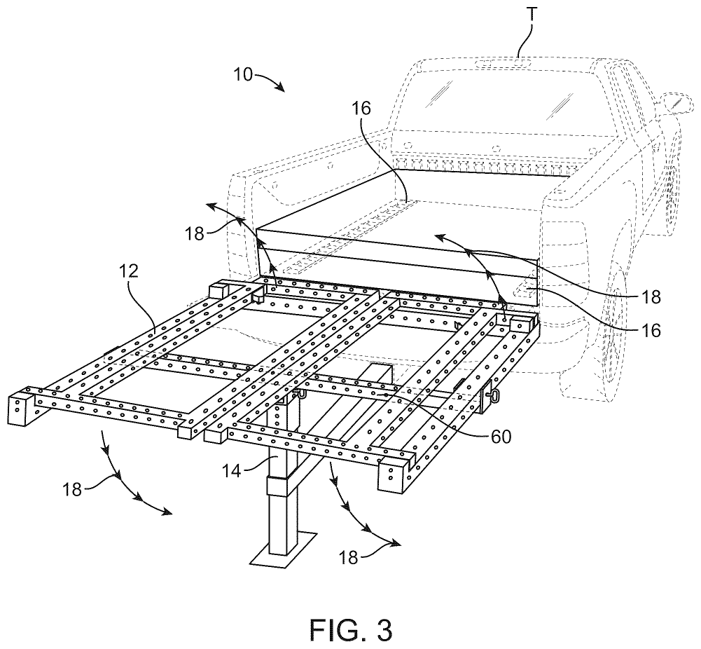

As portable exercise station 12 is pulled out of truck bed TB, portable exercise station 12 is configured to couple with the hitch attachment assembly 14, such that portable exercise station 12 can move pivotally with respect to the hitch attachment assembly 14. The coupling mechanism between portable exercise station 12 and hitch attachment assembly 14 may incorporate a quick-connect system utilizing a spring-loaded locking pin or a twist-lock mechanism for rapid engagement and disengagement. Hitch attachment assembly 14 may be mounted on rear end of the truck bed TB or directly on the vehicle's hitch receiver, depending on the specific configuration of vehicle and portable exercise station 12. The pivotal movement is essential for deploying the exercise station into its functional position outside the truck bed TB. FIG. 3 depicts arrows 18 that indicate the required pivotal movement of the portable exercise station 12 for deployment after the portable exercise station 12 has been pulled out of the truck bed TB using the rails 16. The pivotal movement typically ranges from 90 to 180 degrees, allowing for versatile positioning of portable exercise station 12 relative to truck T. The pivotal movement may enable the exercise station 12 to swing outwards and lock into a stable position perpendicular or at an angle to the truck bed TB, depending on the intended use. In an alternative embodiment, the pivotal mechanism may include detent positions at 45-degree intervals to provide multiple stable positioning options. The locking mechanism for the pivotal movement may incorporate a ratcheting system or a pin-and-hole arrangement to ensure secure positioning during exercise activities.

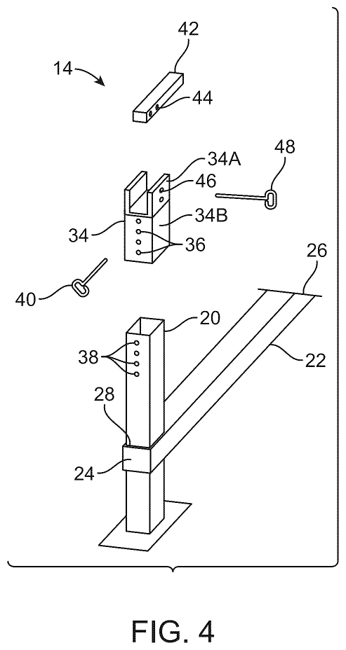

FIG. 4 is an exploded view of hitch attachment assembly 14 used for deployment of portable exercise station 12, in accordance with one embodiment of the present subject matter. Hitch attachment assembly 14 includes base column 20. Base column 20 is configured to be coupled to tow-hitch of truck T via connector 22. Base column 20 may be constructed from high-strength steel tubing to provide adequate structural support for exercise loads up to 500 pounds. Tow-hitch is typically located at rear of truck T and is designed to receive various types of attachments for towing or other purposes. Connector 22 serves as an intermediary component that facilitates attachment of portable exercise station 12 to truck T. In an alternative embodiment, connector 22 may include anti-wobble features such as wedge inserts or cam-operated tightening mechanisms to eliminate play between the connector and the hitch receiver, thereby enhancing stability during exercise use.

More specifically, connector 22 has first operative end 24 and second operative end 26. First operative end 24 is configured to interface with tow-hitch of truck T, while second operative end 26 is designed to couple with base column 20. First operative end 24 may be configured with a square or rectangular cross-section matching standard hitch receiver dimensions. Adjacent to first operative end 24, connector 22 includes through-hole 28. Through-hole 28 is dimensioned such that connector 22 can slide over base column 20 and can be snug fitted at to base column 20, as shown in FIG. 4. Through-hole 28 may have suitable diameter to accommodate standard hitch pins, and may include a bushing or sleeve to reduce wear and provide a more secure connection. In an alternative embodiment, through-hole 28 may be threaded to accept a threaded fastener instead of a standard hitch pin, providing enhanced security and eliminating the need for additional clips or retainers.

Hitch attachment assembly 14 further includes head extension 34. Head extension 34 is defined by U-shaped head extension bracket 34A and connector portion 34B extending from U-shaped head extension bracket 34A. U-shaped head extension bracket 34A may have an opening width of 2 to 4 inches and a depth of 1 to 4 inches to accommodate various coupler configurations. U-shaped head extension bracket 34A is configured for receiving a coupler, while connector portion 34B interfaces with base column 20. Connector portion 34B includes first connector apertures 36 that are configured to align with second connector apertures 38 configured on base column 20 when connector portion 34B is inserted or received into interior of base column 20, which has hollow configuration. Hollow configuration allows for nesting of connector portion 34B within base column 20, thereby providing additional stability and structural integrity. In an alternative embodiment, connector portion 34B may include a tapered or stepped configuration to provide a more secure fit within the base column 20, and may incorporate anti-rotation features such as flats or keyways to prevent unwanted rotation during use.

Pin 40 is used to lock movement of head extension 34 with respect to base column 20. Pin 40 may be constructed from hardened steel and may include a spring-loaded detent mechanism for quick insertion and removal. By inserting pin 40 through aligned apertures 36 and 38, head extension 34 is secured in place, thus preventing any unwanted movement or detachment during use. Use of multiple apertures allows for adjustable positioning of head extension 34, which can be beneficial for accommodating different exercise routines or user preferences. The adjustment range may provide height variations of 6 to 12 inches to accommodate users of different statures. In some embodiments, head extension 34 may also feature additional locking mechanisms, such as clamping system or threaded fastener, to enhance security and ease of use. An alternative embodiment may incorporate a cam-lever mechanism that allows for tool-free adjustment and locking of the head extension position.

Hitch attachment assembly 14 further includes a coupler 42 configured to be received into U-shaped head extension bracket 34A. Coupler 42 has coupler apertures 44 configured thereon, where coupler apertures 44 are designed for alignment with apertures 46 configured on U-shaped head extension bracket 34A. The coupler 42 may be manufactured from high-strength steel or aluminum alloy with a load rating of 300 to 600 pounds to ensure safe operation during exercise activities. When coupler apertures 44 of coupler 42 align with apertures 46 of U-shaped head extension bracket 34A, pin 48 is inserted to lock coupler 42 in place within U-shaped head extension bracket 34A. Pin 48 may include a safety clip or cotter pin to prevent accidental removal during operation. In an alternative embodiment, coupler 42 may incorporate a threaded connection or bayonet-style coupling for enhanced security and ease of connection.

Coupler 42 is configured to allow for pivotal movement of portable exercise station 12 with respect to base column 20. Coupler 42 connects to a detachable cross member 60. In some implementations, a bearing interface is integrated within coupler 42. The bearing interface includes a series of ball bearings or roller bearings positioned between an inner race and an outer race (not shown). The inner race is fixedly attached to detachable cross member 60 through a press-fit connection or welded joint, while the outer race is secured within the housing of coupler 42 through a threaded retaining ring or snap-fit mechanism. This bearing configuration enables smooth rotational movement of portable exercise station 12 about a vertical axis defined by the coupler 42. The bearing interface distributes rotational loads evenly across multiple contact points and reduces friction during pivotal movement, allowing the portable exercise station 12 to rotate through a range of 90 to 270 degrees relative to hitch attachment assembly 14. Pivotal movement provided by coupler 42 enables portable exercise station 12 to rotate around vertical axis, allowing for vertical deployment on ground, as indicated in FIG. 3 using arrows 18. The pivotal mechanism may provide a rotation range of 90 to 270 degrees, with detent positions every 45 degrees for precise positioning. In some cases, coupler 42 may incorporate a thrust bearing or bushing to distribute loads evenly and reduce wear during pivotal movement.

In one embodiment, the bearing interface of coupler 42 may be designed with a cylindrical or spherical configuration that allows for smooth rotation of portable exercise station 12 around base column 20. The bearing interface comprises a plurality of ball bearings or needle bearings arranged in a circular pattern within an annular groove formed in the cylindrical housing of coupler 42. The bearings are retained by upper and lower bearing races. The upper race is integrated into a removable cap that secures the bearing assembly, and the lower race is machined directly into the base of the cylindrical housing. The bearing interface may utilize sealed ball bearings or bronze bushings with a coefficient of friction less than 0.1 to ensure smooth operation. The bearing interface reduces friction through the rolling or sliding contact between the bearing elements and the races, ensuring that rotation is controlled and stable during use. The bearing mechanism may be designed to support weight of portable exercise station 12 and any additional load from exercise equipment or user through the distribution of forces across multiple bearing contact points.

In another alternative embodiment, coupler 42 may be equipped with dampening mechanism to control speed and smoothness of pivotal movement. The dampening mechanism is integrated with the bearing interface and comprises a viscous fluid chamber formed within the cylindrical housing of coupler 42, wherein the chamber contains a dampening fluid such as hydraulic oil or silicone-based fluid. A series of vanes or paddles are attached to the inner race of the bearing interface and extend into the dampening fluid chamber, creating resistance to rotational movement through fluid displacement. The dampening mechanism may include hydraulic or pneumatic components, such as pistons or cylinders, that provide resistance to rotational movement, ensuring gradual and controlled pivot action. The dampening mechanism may provide adjustable resistance to accommodate different user preferences and deployment scenarios through the use of adjustable orifices or bypass valves that control fluid flow within the dampening chamber. In yet another embodiment, the dampening mechanism may incorporate a magnetic damper comprising permanent magnets attached to the outer race and conductive plates attached to the inner race, creating eddy current resistance during rotation, or a friction-based system that provides consistent resistance throughout the range of motion through the use of spring-loaded friction pads that contact the rotating bearing races. The dampening mechanism may also include a bypass valve or release mechanism that allows for rapid deployment in emergency situations or when quick setup is required.

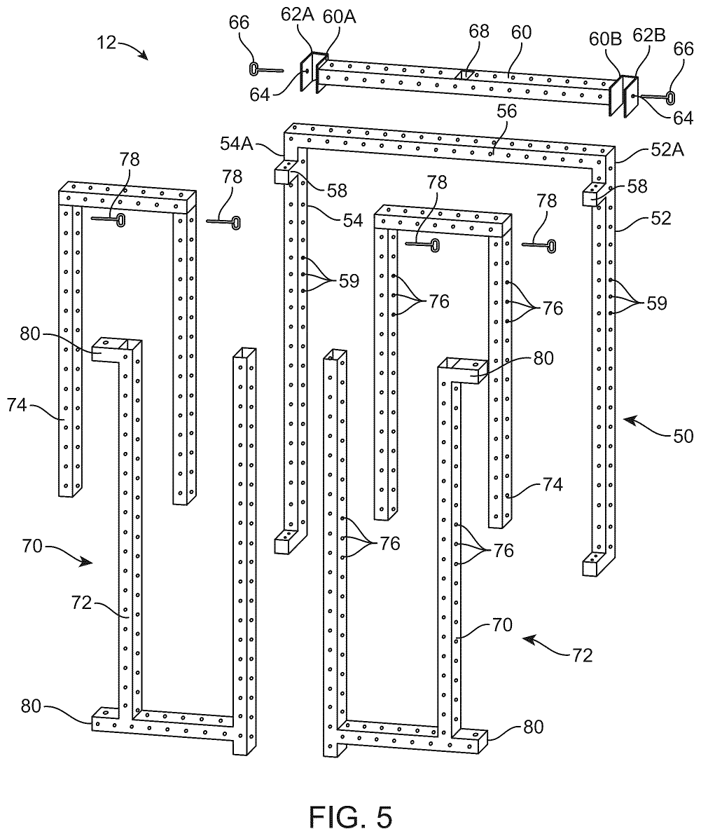

FIG. 5 is an exploded view of portable exercise station 12, in accordance with one embodiment of the present subject matter. Portable exercise station 12 includes an H-frame 50 defined by a first column 52, a second column 54, and a first cross member 56 adjoined to operative top ends 52A, 54A of first column 52 and second column 54. H-frame 50 provides structural support and forms the primary framework of portable exercise station 12. Each of first and second columns 52, 54 includes a plurality of column apertures 59 formed in a spaced apart configuration along the length of first and second columns 52, 54. The spaced apart configuration of column apertures 59 allows for adjustability in positioning various attachments and accessories along columns. In one embodiment, all the components of H-frame 50 have a perforated configuration defined by arrays of apertures configured thereon. The perforated design may extend along 80% to 90% of the column length to maximize adjustment options while maintaining structural integrity. Adjacent to operative top ends 52A, 54A, H-frame 50 includes support extensions 58, which serve as connection points for additional components or accessories, such as foldable load-bearing supports or other exercise equipment. Support extensions 58 may extend 2 to 4 inches from first column 52 and second column 54 and may include reinforcement gussets to handle the additional loads imposed by the foldable supports. In an alternative embodiment, H-frame 50 may be constructed from aluminum alloy to reduce weight while maintaining strength, or may incorporate composite materials such as carbon fiber reinforced polymer for applications requiring maximum portability.

Portable exercise station 12 further includes a detachable cross member 60. Detachable cross member 60 is a structural component that en hances stability and rigidity of the H-frame 50 during use. Detachable cross member 60 may be constructed from the same material as the H-frame 50 and may have a length spanning the distance between first column 52 and second column 54. Detachable cross member 60 has a first and second operative ends 60A, 60B. At each of first and second operative ends 60A, 60B, detachable cross member 60 includes a first and second U-shaped brackets 62A, 62B. First and second U-shaped brackets 62A, 62B are configured to engage with first and second columns 52, 54 by receiving first column 52 and second column 54 within the U-shaped opening of each bracket 62A, 62B. The U-shaped configuration defines an open channel that partially surrounds the perimeter of the respective column (first column 52 and second column 54) when engaged. U-shaped brackets 62A, 62B may have an opening width that is 0.1 to 0.2 inches larger than first column 52 and second column 54 cross-section to allow for easy installation while maintaining a secure fit. The engagement mechanism operates by sliding the U-shaped opening of each U-shaped bracket 62A, 62B over the respective first column 52 and second column 54 until the U-shaped bracket 62A, 62B is positioned at the desired location along the column length. Each U-shaped bracket 62A, 62B has a bracket aperture 64 that extends through both side walls of the U-shaped configuration. Detachable cross member 60 is configured to interface with first and second columns 52, 54 using first and second U-shaped brackets 62A, 62B such that bracket apertures 64 configured on first and second U-shaped brackets 62A, 62B align with column apertures 59 configured on first and second columns 52, 54 when the U-shaped brackets are properly positioned around the columns (first column 52 and second column 54). Pins 66 are inserted through aligned bracket apertures 64 and column apertures 59 to facilitate locking of detachable cross member 60 to first and second columns 52, 54.

Here, pins 66 pass through bracket apertures 64 and the corresponding column apertures 59 to prevent relative movement between U-shaped brackets 62A, 62B, and first column 52 and second column 54. Pins 66 may include spring-loaded detent mechanisms or threaded ends with wing nuts for secure attachment and easy removal. In an alternative embodiment, U-shaped brackets 62A, 62B may incorporate cam-operated clamps that eliminate the need for pins and provide tool-free attachment and removal of the detachable cross member by applying clamping force directly to the column surfaces through the U-shaped opening.

In one embodiment, first and second columns 52, 54 may be height adjustable telescopic columns. Height adjustable telescopic columns allow users of different heights to adjust the height of portable exercise station 12 according to their specific exercise requirements. The telescopic adjustment may provide a height range of 6 to 8 feet, with adjustment increments of 2 to 4 inches. The telescopic adjustment mechanism may include inner and outer telescoping sections that slide relative to each other and are secured in place using pins or locking collars inserted through corresponding apertures. The telescopic sections may have an overlap of at least 12 inches to ensure structural integrity and load-bearing capacity. Alternative embodiments may use different adjustment mechanisms, such as a ratchet-and-pawl system or a hydraulic lift mechanism, to provide additional ease of use or load-bearing capacity. A gas-spring assisted mechanism may also be incorporated to reduce the effort required for height adjustment, particularly beneficial when adjusting under load. In yet another embodiment, the telescopic columns may include graduated markings or digital readouts to facilitate precise and repeatable height settings.

Detachable cross member 60 further includes a detachable cross member aperture 68. The detachable cross member aperture 68 may be centrally located on detachable cross member 60 and may have a suitable diameter to accommodate various coupler configurations. Referring to FIG. 3, FIG. 4, and FIG. 5, detachable cross member aperture 68 is configured to interface with coupler 42. Coupling aperture 68 provides a connection point for coupler 42, allowing portable exercise station 12 to pivot and move as required. The pivotal movement of portable exercise station 12 indicated by arrows 18 in FIG. 3 is facilitated by the connection of detachable cross member 60 with coupler 42 through detachable cross member aperture 68.

In alternative embodiments, detachable cross member aperture 68 may be designed with a reinforced sleeve or bushing to enhance durability and reduce wear during repeated use. The reinforced sleeve may be constructed from hardened steel or bronze and may be press-fitted or welded into the coupling aperture. In another embodiment, coupler 42 could also incorporate a quick-release mechanism that allows for rapid disconnection of portable exercise station 12 from the truck or base column, providing additional versatility for different exercise setups or transportation needs. The quick-release mechanism may include a spring-loaded pin, cam-operated lever, or quarter-turn fastener that can be operated without tools. In yet another embodiment, detachable cross member aperture 68 may be designed with multiple positions or orientations to allow for different attachment angles, providing additional flexibility in exercise station positioning and use.

Referring to FIG. 5, portable exercise station 12 further includes foldable load-bearing supports 70. Foldable load-bearing supports 70 are height-adjustable load-bearing structures that provide additional stability to portable exercise station 12 during use. Foldable load-bearing supports 70 may have a load capacity of 300 to 500 pounds each and may extend 24 to 36 inches from H-frame 50 when fully deployed. Foldable load-bearing supports 70 include first U-shaped members 72 and second U-shaped members 74 that are assembled to form a rectangular configuration. Second U-shaped member 74 is configured for telescopic fitment within first U-shaped member 72, allowing for adjustable height settings. In the telescopic configuration, second U-shaped member 74 may be positioned in an inverted orientation, with the open end facing downward, and inserted into first U-shaped member 72. This inverted positioning of second U-shaped member 74 allows for stable telescopic engagement while providing a secure base when the foldable load-bearing supports 70 are deployed.

U-shaped member apertures 76 are formed on both first and second U-shaped members 72, 74. U-shaped member apertures 76 are aligned and locked in place using pins 78. U-shaped member apertures 76 may be spaced. The choice of U-shaped member apertures 76 at which pins 78 are inserted depends upon the desired height for the user, providing flexibility to accommodate different exercises or user preferences. Pins 78 may include spring-loaded detent mechanisms for quick adjustment and secure locking. In one embodiment, all the components of foldable load-bearing supports 70 have a perforated configuration defined by arrays of apertures configured thereon. The perforated design may extend along the full length of the support members to maximize adjustment options and provide mounting points for accessories.

In alternative embodiments, foldable load-bearing supports 70 may be equipped with additional features, such as adjustable feet or rubberized grips, to enhance stability on uneven surfaces. The adjustable feet may provide up to 2 inches of leveling adjustment and may include swivel pads to accommodate sloped surfaces. The supports could also include additional locking mechanisms, such as clamps or cam locks, to provide a more secure and rigid setup. In another embodiment, foldable load-bearing supports 70 may incorporate shock-absorbing elements such as rubber bushings or spring-loaded mechanisms to reduce vibration and noise during exercise activities. The supports may also include integrated storage compartments or hooks for holding exercise accessories such as resistance bands, towels, or water bottles.

Foldable load-bearing supports 70 further include pivot extensions 80 configured for interfacing with support extensions 58 on H-frame 50. Pivot extensions 80 facilitate the pivotal and foldable connection of foldable load-bearing supports 70 with H-frame 50. pivot extensions 80 may incorporate heavy-duty hinges with a load rating of 200 to 400 pounds and may include grease fittings for long-term maintenance. This configuration allows foldable load-bearing supports 70 to be folded against H-frame 50 when not in use, minimizing the footprint of portable exercise station 12 for convenient storage and transport. The folding mechanism may provide a fold angle of 90 to 180 degrees, allowing foldable load-bearing supports 70 to lie flat against H-frame 50. The folded configuration of portable exercise station 12 is shown in FIG. 1 through FIG. 3, where foldable load-bearing supports 70 are folded and can be seen as being conveniently accommodated on truck bed TB. In an alternative embodiment, pivot extensions 80 may include gas springs or torsion springs to assist with the folding and unfolding process, reducing the effort required by the user and providing controlled movement.

In alternative embodiments, foldable load-bearing supports 70 may include locking hinges or detents that secure the supports in both deployed and folded positions. The locking mechanisms may include spring-loaded pins, cam-operated latches, or over-center mechanisms that provide positive engagement. This feature ensures that the supports remain stable during transport and do not unintentionally unfold. The locking force may range from 50 to 100 pounds to ensure secure engagement while still allowing for manual operation. Additional configurations may incorporate quick-release latches or magnetic locks to facilitate easier folding and unfolding of the load-bearing supports. In another embodiment, foldable load-bearing supports 70 may include position indicators or alignment guides to ensure proper positioning during setup and folding operations. Foldable load-bearing supports 70 may also incorporate safety features such as pinch-point guards or soft-close mechanisms to prevent injury during operation.

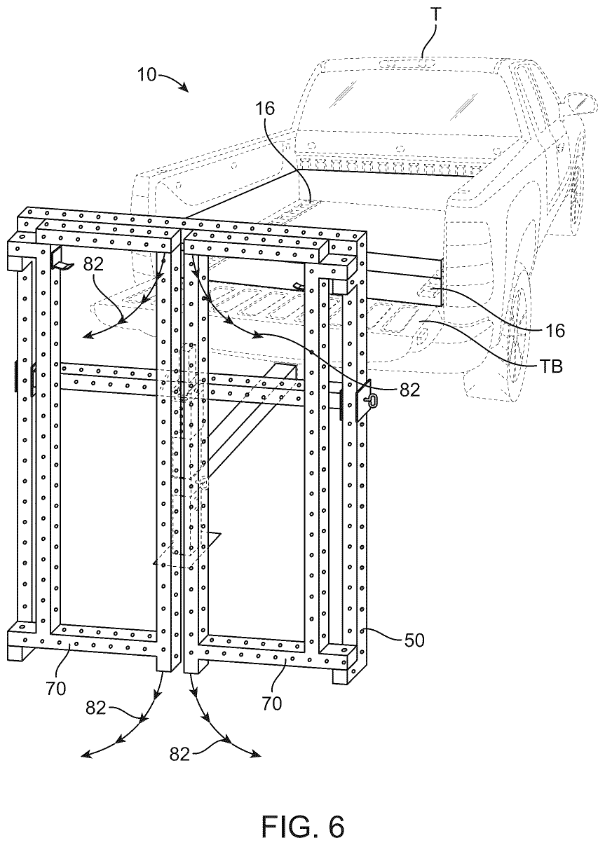

FIG. 6 is a perspective view of portable exercise station 12 being partially deployed on ground, in accordance with one embodiment of the present subject matter. As shown in FIG. 6, portable exercise station 12 is partially deployed on ground, illustrating an intermediate stage in the setup process. Arrows 82 indicate the movement of foldable load-bearing supports 70 required for complete deployment of portable exercise station 12.

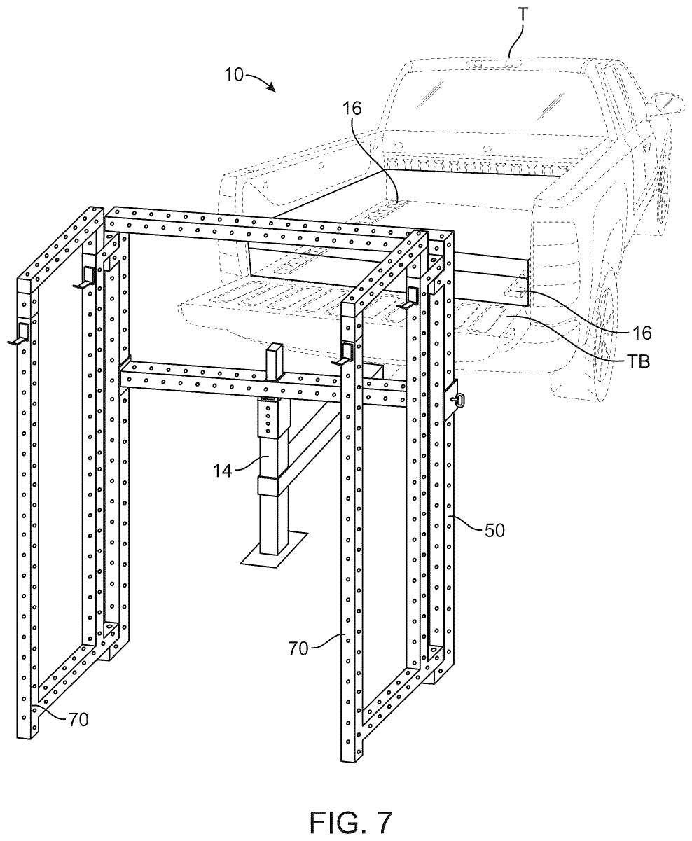

FIG. 7 is a perspective view of portable exercise station 12 being fully deployed on ground, in accordance with one embodiment of the present subject matter. In this configuration, foldable load-bearing supports 70 are completely opened and extended outward from H-frame 50, forming a stable base for exercise use. The complete deployment of foldable load-bearing supports 70 provides the necessary stability and balance required for various exercises, ensuring that the portable exercise station 12 remains stationary and secure during use. The supports may also be equipped with ground-engaging pads or spikes to further enhance stability on different surfaces, such as grass, dirt, or uneven terrain. The ground-engaging elements may be adjustable or interchangeable to accommodate different surface conditions, with options including rubber pads for hard surfaces, spikes for soft ground, or leveling feet for uneven terrain. In an alternative embodiment, portable exercise station 12 may include integrated leveling systems or stabilizing jacks that can be deployed to ensure the station remains level and stable regardless of ground conditions.

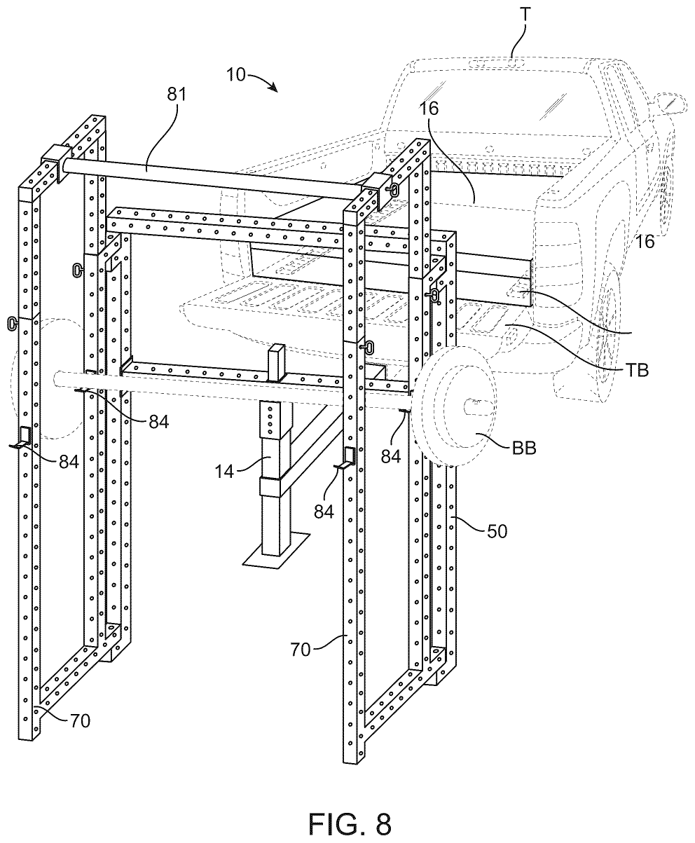

FIG. 8 is a perspective view of portable exercise station 12 being deployed on ground and having a barbell placed thereon, in accordance with one embodiment of the present subject matter. As shown in FIG. 8, foldable load-bearing supports 70 are fully extended to display a final ready-to-use configuration of portable exercise station 12. One exemplary application for portable exercise station 12 is its use as a squat rack. The squat rack configuration may accommodate barbells ranging from 5 to 7 feet in length and may support weights up to 400 pounds. Holders 84 are configured on foldable load-bearing supports 70 for holding barbell BB thereon. Holders 84 may be J-shaped or U-shaped and may include protective padding to prevent damage to the barbell. In one embodiment, holders 84 are removable holders that can be positioned at various heights along foldable load-bearing supports 70, while in other embodiment, holders 84 may be integral to foldable load-bearing supports 70. The removable holders 84 may utilize a pin-and-hole attachment system or a clamp mechanism for secure positioning. In an alternative embodiment, holders 84 may be adjustable in angle to accommodate different exercise positions or to provide optimal barbell placement for various user heights. Holders 84 may also include safety features such as locking mechanisms or backup supports to prevent accidental barbell displacement during exercises.

In an alternative embodiment, as shown in FIG. 8, portable exercise station 12 further includes a pull-up bar 81. Pull-up bar 81 is designed to be attached to foldable load-bearing supports 70 at operative top edge defined by first and second U-shaped members 72, 74. Pull-up bar 81 may be constructed from steel, aluminum, or other materials suitable for supporting the weight of a user during pull-up exercises. Pull-up bar 81 may be knurled or textured to provide enhanced grip, and may include multiple grip positions such as wide, narrow, and neutral grips. Pull-up bar 81 allows users to perform various upper body exercises, including pull-ups, chin-ups, and hanging leg raises. In some embodiments, pull-up bar 81 may include grips or textured surfaces to enhance user comfort and prevent slipping during exercises. Pull-up bar 81 may also incorporate ergonomic features such as angled grips or rotating handles to reduce stress on wrists and forearms. In an alternative embodiment, pull-up bar 81 may be adjustable in height or may include multiple bars at different heights to accommodate users of various statures and exercise preferences. Pull-up bar 81 may also be removable to facilitate storage and transport of portable exercise station 12.

In another implementation, pull-up bar 81 can be attached to first and second columns 52, 54. When attached to first and second columns 52, 54, pull-up bar 81 functions as a handle, providing a grip for pulling portable exercise station 12 out of storage housing 86. This implementation adds versatility to portable exercise station 12 by allowing the pull-up bar 81 to serve dual purposes: facilitating storage and retrieval of exercise station 12 and supporting exercises such as pull-ups. In yet another embodiment, pull-up bar 81 may be designed with telescoping sections to allow for width adjustment, accommodating different grip preferences and exercise variations. Pull-up bar 81 may also include attachment points for resistance bands, suspension trainers, or other exercise accessories to further expand the range of possible exercises. In an alternative configuration, multiple pull-up bars may be provided at different heights or orientations to create a comprehensive upper body training station.

The installation and use of portable exercise station 12 involves a systematic deployment process that transforms the compact storage configuration into a fully functional exercise platform. Initially, portable exercise station 12 is stored within storage housing 86 in truck bed TB, with foldable load-bearing supports 70 folded against H-frame 50 to minimize space requirements. The user begins the installation process by accessing the storage housing 86 and utilizing pull-up bar 81 as a handle to grip first and second columns 52, 54, facilitating the extraction of the exercise station from the storage compartment.

The deployment sequence commences with the user pulling portable exercise station 12 out of truck bed TB using rails 16, which provide smooth sliding motion and support the weight of the exercise station during extraction. As the exercise station is pulled to its extended position, coupler 42 automatically engages with hitch attachment assembly 14, establishing a secure connection point that enables pivotal movement. The user then initiates the pivotal deployment by rotating portable exercise station 12 relative to truck bed TB, as indicated by arrows 18 in FIG. 3. The bearing interface within coupler 42 facilitates smooth rotation while supporting the weight of the exercise station throughout this pivotal movement.

Once the exercise station reaches the desired angular position, the user proceeds to deploy foldable load-bearing supports 70 by releasing any locking mechanisms and extending foldable load-bearing supports 70 outward from H-frame 50. Pivot extensions 80 allow foldable load-bearing supports 70 to unfold through a range of 90 to 180 degrees, with the user guiding the movement as indicated by arrows 82 in FIG. 6. The telescopic configuration of first and second U-shaped members 72, 74 enables height adjustment by aligning support apertures 76 and securing the desired height with support pins 78. This adjustment process allows users to customize the exercise station height according to their specific requirements and exercise preferences.

For barbell exercises, the user positions holders 84 at the appropriate height along foldable load-bearing supports 70 by aligning the holder apertures with column apertures 59 and securing them with pins. Holders 84 may be configured in J-shaped or U-shaped configurations to accommodate different barbell diameters and exercise requirements. When performing squats, the user loads barbell BB onto holders 84 at shoulder height, steps under the barbell, and lifts it from the holders to perform the exercise movement. The stable base provided by the deployed foldable load-bearing supports 70 ensures that portable exercise station 12 remains stationary during dynamic movements, with the ground-engaging elements providing additional stability on various surface conditions.

For pull-up exercises, pull-up bar 81 is positioned at the operative top edge of foldable load-bearing supports 70, spanning between first and second U-shaped members 72, 74. The user may adjust the height of pull-up bar 81 by modifying the telescopic configuration of the support members, ensuring optimal positioning for different user heights and exercise variations. The knurled or textured surface of pull-up bar 81 provides enhanced grip security, while multiple grip positions accommodate wide, narrow, and neutral grip preferences. During pull-up execution, the user grasps pull-up bar 81 and performs the exercise movement, with the structural integrity of H-frame 50 and the stability provided by foldable load-bearing supports 70 supporting the dynamic loads generated during the exercise.

The modular design of portable exercise station 12 allows for rapid reconfiguration between different exercise applications. Users may reposition holders 84 to different heights for bench pressing applications, attach additional accessories such as dip bars or resistance band anchor points, or modify the arrangement of detachable cross member 60 to accommodate specific exercise requirements. The perforated configuration of H-frame 50 components, defined by arrays of apertures, provides multiple attachment points for accessories and enables precise positioning adjustments to optimize the exercise station for various training modalities.

The configuration of foldable load-bearing supports 70 and H-frame 50 allows for multiple exercise applications beyond the squat rack function. For example, portable exercise station 12 may be used for bench pressing, pull-ups, or other strength training exercises by attaching additional accessories or modifying the arrangement of foldable supports and cross members. The modular design may accommodate accessories such as dip bars, landmine attachments, cable systems, or suspension anchor points. The portable exercise station may also be configured for functional training exercises such as battle rope anchoring, resistance band training, or suspension training. The foldable design also facilitates easy transport and storage, as portable exercise station 12 can be compactly folded and stored in a vehicle or a small storage space when not in use. The folded dimensions may be approximately 60% smaller than the deployed configuration, making it suitable for storage in standard truck beds, garages, or storage sheds. In an alternative embodiment, the exercise station may include integrated wheels or casters to facilitate movement when folded, and may incorporate a carrying case or protective cover for long-term storage or transport in adverse weather conditions.

The present invention provides several advantages over the prior art systems. Unlike the complex weight rack described in AU2017101677A4, which requires considerable setup time and manual adjustment of jacks, the portable exercise station 12 of the present invention may be rapidly deployed with minimal effort. The rail-based system 16 allows for smooth extraction from truck bed TB, and the pivotal coupling mechanism enables quick positioning without the need for multiple assembly steps or heavy lifting of components.

In contrast to the detachable exercise device of US20070259764A1, which requires multiple steps to secure the device to a vehicle's tow hitch and assemble exercise components, the present invention may utilize a streamlined hitch attachment assembly 14 with coupler 42 that provides single-point connection and controlled pivotal movement. The bearing interface incorporated in coupler 42 may reduce friction and allow for smooth deployment, eliminating the cumbersome setup process that limits the effectiveness of prior art systems.

The present invention also addresses the space utilization issues found in U.S. Pat. No. 9,3021,44B1, which occupies valuable roof space and involves safety concerns during mounting and dismounting. The portable exercise station 12 may be stored within truck bed TB using storage housing 86, preserving roof space for other transportation needs while maintaining easy accessibility. The rail system 16 may eliminate the need for overhead lifting and reduces safety risks associated with roof-mounted systems.

The modular design of the present invention may provide enhanced versatility compared to prior art systems. The detachable cross member 60 with U-shaped brackets 62A, 62B allows for adjustable positioning and secure attachment without requiring specialized tools or complex assembly procedures. The foldable load-bearing supports 70 may be height-adjustable through telescopic fitment of first and second U-shaped members 72, 74, providing flexibility that is not available in fixed-height prior art systems.

The present invention may also offer improved stability through the deployment of foldable load-bearing supports 70 that extend outward from H-frame 50 to create a wide, stable base. This configuration may provide superior stability compared to prior art systems that rely primarily on vehicle weight or limited ground contact points. The ground-engaging elements may be adjustable or interchangeable to accommodate different surface conditions, enhancing versatility across various outdoor environments.

The compact storage capability of the present invention may represent a significant advancement over prior art systems. When folded, the portable exercise station 12 may occupy approximately 60% less space than its deployed configuration, fitting efficiently within standard truck beds without compromising vehicle utility. The storage housing 86 with compartmentalized upper compartment 88 and lower compartment 90 may provide organized storage for both the exercise station and associated equipment, addressing the storage limitations found in existing systems.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the subject matter, it is intended that all matter contained in the above description or shown in the accompanying drawings shall be interpreted as illustrative and not in a limiting sense.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. It is contemplated that additional embodiments are within the spirit and true scope of the disclosed subject matter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A portable exercise station, comprising:
an H-frame comprising a first column, a second column, and a first cross member, wherein said first cross member is adjoined to operative top ends of said first column and said second column;
a detachable cross member comprising first and second U-shaped brackets, positioned at a first operative end and a second operative end of said detachable cross member, wherein said first and second U-shaped brackets are configured to engage with said first column and said second column;
foldable load-bearing supports pivotally connected to said H-frame, wherein said foldable load-bearing supports are height-adjustable and configured to fold against said H-frame when not in use and to extend outward from said H-frame to provide stability during use, wherein said foldable load-bearing supports comprise a first U-shaped member and a second U-shaped member, wherein said second U-shaped member is configured for telescopic fitment within said first U-shaped member; and
a hitch attachment assembly configured to connect said portable exercise station to a truck bed of a truck, wherein said hitch attachment assembly comprises a coupler configured to allow pivotal movement of said portable exercise station.

2. The portable exercise station of claim 1, wherein each of said first column and said second column comprises a plurality of column apertures formed in a spaced apart configuration along a length thereof.

3. The portable exercise station of claim 2, wherein each of said first and second U-shaped brackets comprises bracket apertures configured to align with said column apertures on said first column and said second column.

4. The portable exercise station of claim 3, further comprising locking pins configured to secure said detachable cross member to said first column and said second column through aligned said bracket apertures and said column apertures.

5. The portable exercise station of claim 1, wherein said detachable cross member comprises a detachable cross member aperture configured to interface with said coupler of said hitch attachment assembly, wherein said coupler is configured to engage with said detachable cross member aperture to enable pivotal movement of said portable exercise station relative to said hitch attachment assembly.

6. The portable exercise station of claim 1, wherein each of said first U-shaped member and said second U-shaped member comprises U-shaped member apertures, and wherein said first U-shaped member and said second U-shaped member comprise support pins configured for insertion through aligned said U-shaped member apertures.

7. The portable exercise station of claim 1, wherein said foldable load-bearing supports comprise pivot extensions, wherein said H-frame comprises support extensions, and wherein said pivot extensions interface with said support extensions.

8. The portable exercise station of claim 1, wherein said hitch attachment assembly comprises a base column configured to couple to a tow-hitch of said truck and a head extension comprising a U-shaped head extension bracket configured to receive said coupler.

9. The portable exercise station of claim 8, wherein said coupler comprises a bearing interface configured to allow pivotal movement of said portable exercise station relative to said base column.

10. The portable exercise station of claim 1, further comprising rails configured to be affixed to said truck bed and to support said H-frame for sliding movement between a stored position within said truck bed and an extended position outside said truck bed.

11. The portable exercise station of claim 1, further comprising holders provided on said foldable load-bearing supports for supporting exercise equipment.

12. The portable exercise station of claim 1, further comprising a pull-up bar configured to be attached to said foldable load-bearing supports.

13. The portable exercise station of claim 1, wherein said first column and said second column are height-adjustable telescopic columns.

14. The portable exercise station of claim 1, further comprising a storage housing having a compartmentalized configuration defined by an operative upper compartment and an operative lower compartment, wherein said operative lower compartment is configured to accommodate said portable exercise station and said hitch attachment assembly, and said operative upper compartment is configured to store exercise equipment.

15. A portable exercise station system, comprising:
a truck bed;
a portable exercise station comprising an H-frame having a first column, a second column, and a first cross member, wherein said first cross member is adjoined to operative top ends of said first column and said second column;
rails affixed to said truck bed, wherein said rails are configured to support said H-frame for sliding movement between a stored position within said truck bed and an extended position outside said truck bed;
a hitch attachment assembly comprising a base column configured to couple to a tow-hitch of a truck, and a coupler configured to allow pivotal movement of said portable exercise station;
foldable load-bearing supports pivotally connected to said H-frame and configured to fold against said H-frame when not in use and to extend outward from said H-frame to provide a stable base for exercise use; and
a storage housing comprising a compartmentalized configuration defined by an operative upper compartment and an operative lower compartment, wherein said operative lower compartment is configured to accommodate said portable exercise station and said hitch attachment assembly, and said operative upper compartment is configured to store exercise equipment.

16. The portable exercise station system of claim 15, further comprising a detachable cross member comprising first and second U-shaped brackets, positioned at a first operative end and a second operative end of said detachable cross member, wherein said first and second U-shaped brackets are configured to engage with said first column and said second column.

17. The portable exercise station system of claim 16, wherein each of said first column and said second column comprises a plurality of column apertures formed in a spaced apart configuration along a length thereof, and wherein said first and second U-shaped brackets comprise bracket apertures configured to align with said column apertures on said first column and said second column.

18. The portable exercise station system of claim 16, wherein said detachable cross member comprises a detachable cross member aperture configured to interface with said coupler of said hitch attachment assembly.

19. The portable exercise station system of claim 15, wherein said foldable load-bearing supports comprise a first U-shaped member and a second U-shaped member, and wherein said second U-shaped member is configured for telescopic fitment within said first U-shaped member to provide height adjustability.

20. A method of providing a portable exercise station, said method comprising the steps of:
providing an H-frame comprising a first column, a second column, and a first cross member, said first cross member being adjoined to operative top ends of said first column and said second column;
providing a detachable cross member comprising first and second U-shaped brackets, positioned at a first operative end and a second operative end of said detachable cross member, said first and second U-shaped brackets being configured to engage with said first column and said second column;
providing foldable load-bearing supports pivotally connected to said H-frame, said foldable load-bearing supports being height-adjustable and configurable to fold against said H-frame when not in use and to extend outward from said H-frame to provide stability during use, said foldable load-bearing supports comprising a first U-shaped member and a second U-shaped member, said second U-shaped member being configured for telescopic fitment within said first U-shaped member; and
providing a hitch attachment assembly configured to connect said portable exercise station to a truck bed of a truck, said hitch attachment assembly comprising a coupler configured to allow pivotal movement of said portable exercise station.
